(19) United States
(12) Patent Application Publication
(10) Pub. No.: US 2013/0277467 A1
(43) Pub. Date: Oct. 24, 2013

(54) TEST DEVICE FOR ROLLER CRUSHER

(71) Applicant: Andrzej Niklewski, Alto de Pinheiros (BR)

(72) Inventor: Andrzej Niklewski, Alto de Pinheiros (BR)

(73) Assignee: METSO BRASIL INDUSTRIA E COMERCIO LTDA, Sorocaba (BR)

(21) Appl. No.: 13/451,893

(22) Filed: Apr. 20, 2012

(51) Int. Cl. B02C 23/00; B02C 4/02

(52) U.S. Cl. 241/25; 241/101.3

(57) ABSTRACT

A test device for a roller crusher of the type which comprises a pair of crushing rolls rotating in opposite directions for crushing or pulverizing materials comprises
a first sector shaped roll part having a first crushing surface and which is rotatably mounted so that the first crushing surface forms one side of a gap through which materials is fed,
a second sector shaped roll part having a second crushing surface and which is rotatably mounted so that the second crushing surface forms the other side of the gap, and
a sensor arrangement arranged to sense at least one property of the interaction between the materials fed through the gap and the test device.

### TECHNICAL FIELD

The present invention relates to a test device and a method for a test device for a roller crusher of the type which comprises a pair of crushing rolls rotating in opposite directions for crushing or pulverizing materials.

### BACKGROUND ART

When materials, such as stones or minerals, are crushed or pulverized using a roller crusher or a roller grinder equipment, two opposed rotatably mounted rolls, separated from each other by a gap, form a draw in nip where the materials are drawn in, force fed or fed by gravity and crushed or grinded between the rolls and against each other in a process which may be called interparticle crushing. An advantage of this type of crushing is that an effective crushing may be achieved, even to very small grain sizes, with a reduced energy consumption compared to many other crushing techniques. Another positive side is that the level of noise during the process is reduced compared to other crushing techniques.

In order to provide an efficient and well working installation of such a roller crusher or grinder equipment, knowledge of the material to be crushed and estimates of crusher performance are needed in advance, in order to find e.g. a suitable operational gap size between the two rollers, an optimum pressing force and to estimate the power consumption and product gradation and shape.

Previous equipments such as roll simulators in reduced scale or so called “Drop Weigh” test devices for classifying materials have for different reasons proven to be cumbersome to use and present challenges when translating the result to roller crusher applications. They have therefore been less useful. Hence, there is a need for improvement in the area of testing and classifying materials in order to properly design and efficiently set up well working roller crusher equipments.

### SUMMARY OF THE INVENTION

It is an object of the present invention to provide a test device for a roller crusher or grinder equipment which easily and efficiently classifies materials. It is a further object of the invention to provide such a test device which is able to give indications on design parameters for a well working roller crusher or roller grinder installation to be used for crushing or grinding the tested materials.

According to embodiments of the invention, a test device for a roller crusher of the type which comprises a pair of crushing rolls rotating in opposite directions for crushing or pulverizing materials is provided, which comprises a first sector shaped roll part having a first crushing surface and which is rotatably mounted so that the first crushing surface forms one side of a gap through which materials is fed, a second sector shaped roll part having a second crushing surface and which is rotatably mounted so that the second crushing surface forms the other side of the gap. The test device further comprises a sensor arrangement arranged to sense at least one property of the interaction between the materials fed through the gap and the test device.

The test device makes it possible to test materials in full scale, without having to build a complete roller crusher equipment. Thus, compared to making a smaller scale test set up, the test device has the advantage of being able to test the materials as they are, without any downscaling to smaller size materials, as would have been necessary with a test device of a smaller scale. Only making the sector shaped roll parts further provides a much cheaper alternative than entire rolls. The sensor arrangement makes it possible to analyze the impact that the materials crushed in the test device have on the test device, which in turn makes it possible to classify the materials in terms of density and granularity, i.e. sizes of the stones or minerals in the materials. Apart from classifying the materials, the test device can also be used to obtain valuable information on how a roller crusher equipment for the tested materials should be designed or set up, in terms of power needed for the roller crusher equipment, gap between the rolls and optimum pressing force, as information may be provided on product size and shape and effective surface pressure variations as regards the local position in a roll.

The sensor arrangement may comprise an opening sensor arranged to sense the width of the gap. This gap has a direct relationship to the capacity of the equipment, which means that this width may then be used when selecting the distance between the rollers in a roller crusher equipment for the tested material. The measured width of the gap is also used for calculating the density of the materials.

The sensor arrangement may comprise a first pressure sensor arranged to sense the pressure exerted on the sector shaped roll parts by the materials fed through the gap. This in turn gives the compression of the materials, which may be used to determine part of the crushing load, which in turn may be used for optimizing the pressure exerted on the rolls to improve the efficiency of the roller crusher equipment. The sensor arrangement may comprise a second pressure sensor arranged to sense the force used for rotating the sector shaped roll parts. This will give an indication of the power used for rotating the sector shaped roll parts which gives valuable information when setting up an roller crusher equipment since it allows for an optimization regarding the drive train and bearings, or in other words to determine the energy necessary to crush the sample of material, which is another part of the crushing load.

The test device may further comprise a first hydraulic cylinder which is arranged to rotate the first sector shaped roll part, and a second cylinder which is arranged to rotate the second sector shaped roll part. In this way the rotation of the roll parts may be controlled in a simple and efficient manner.

The test device may further comprise a hydraulic unit which is arranged to bias the sector shaped roll parts against each other. Thereby the two roll parts will be forced towards each other creating a properly sized gap in an efficient manner, and at the same time the force used can easily be measured by the sensor arrangement.

The sector shaped roll parts may be arranged to rotate about 45° from a first angular position to a second angular position during a test session. In this way the test device is easily installed and takes up a reasonable amount of space. Further, this amount of rotation gives the sensor arrangement a good chance to measure the desired properties of the interaction between the test device and the tested materials.

### BRIEF DESCRIPTION OF THE DRAWINGS

The invention will now be described in more detail by way of example and with reference to the accompanying schematic drawings, in which:

FIG. 1 shows a test device in a first position.

FIG. 2 shows the test device in a second position.

FIG. 3 schematically shows a crushing scenario in a roller crusher.

FIG. 4 illustrates a method for a test device for a roller crusher.

### DETAILED DESCRIPTION OF PREFERRED EMBODIMENTS OF THE INVENTION

A test device 1 for a roller grinder or roller crusher equipment has a first sector shaped roll part 2 and a second sector shaped roll part 3. Each roll part has a crushing surface 4, 5, respectively. In this context it may be noted that the test device is equally useful for a roller crusher or a roller grinder or for any type of equipment where materials are crushed, grinder or pulverized between two rolls rotating in opposite directions.

The sector shaped roll parts are mounted on the test device 1 so that they are able to rotate about 45° in opposing directions with their crushing surfaces 4 and 5 facing each other. That the roll parts are sector shaped means in this case that their crushing surfaces form an angular sector of an entire roll in a roller crusher equipment. As an example, a part of a roll corresponding to a sector angle of around 45° could be used in the test device.

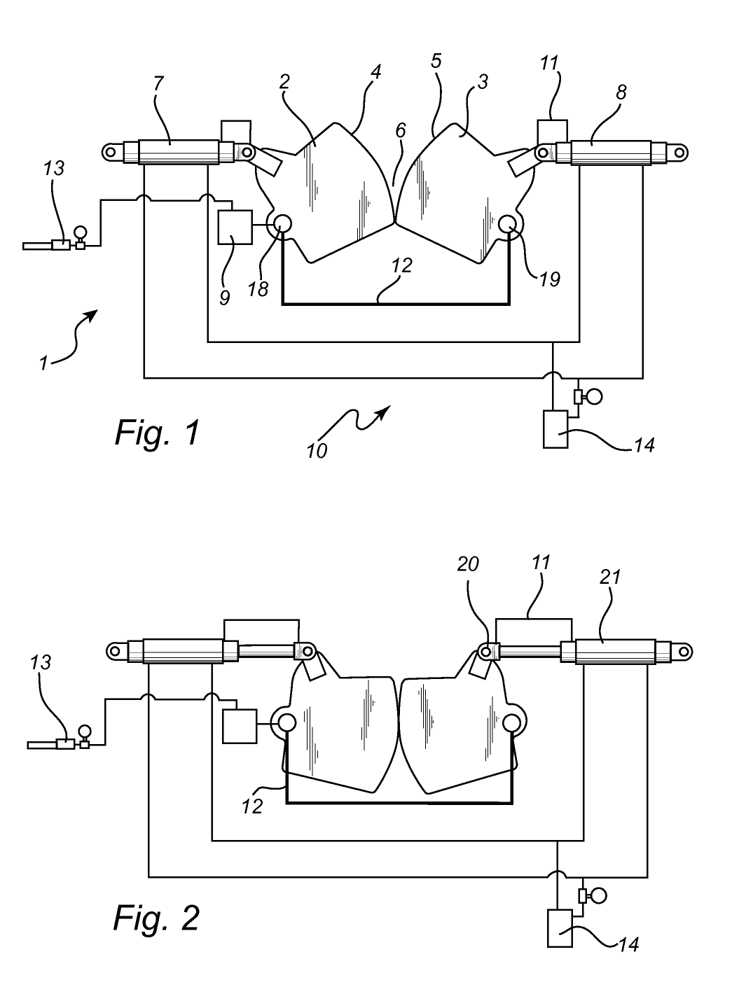

Between the crushing surfaces 4 and 5 a gap 6 is formed, through which materials, e.g. in the form of stones or minerals is fed, by force of gravity or in some other suitable manner. When materials are fed into the gap, a brief session of crushing takes place as the materials are crushed between the rolls and against each other while passing between the sector shaped roll parts 2 and 3, which rotate in opposite directions, from a first position shown in FIG. 1, to a second position shown in FIG. 2, to make the material pass through the gap.

A first hydraulic cylinder 7 is connected to the first sector shaped roll part 2 and a second hydraulic cylinder 8 is connected to the second sector shaped roll part 3, in such a way that the hydraulic cylinders 7 and 8 are able to rotate the sector shaped roll parts 2 and 3 about 45° from the first position shown in FIG. 1 to the second position shown in FIG. 2.

A hydraulic unit 9 is connected to the first sector shaped part 2, in such a way that the first sector shaped roll part 3 is biased against the second sector shaped roll part 3. This in turn means that the crushing surfaces 4 and 5 are biased towards each other and the width of the gap is limited to what is necessary for materials to enter and pass through the gap during a test session.

The test device comprises a sensor arrangement 10, which includes a number of sensors arranged to sense different properties of the interaction between the materials passing through the gap 6 and the test device 1. The sensor arrangement can in turn be connected to a data logging device (not shown), for storing the output received from each of the sensors in the sensor arrangement 10, so that the information on the properties of the interaction between the materials and the test device can be analyzed for use e.g. in setting up a new roller crusher equipment for crushing or pulverizing the tested materials.

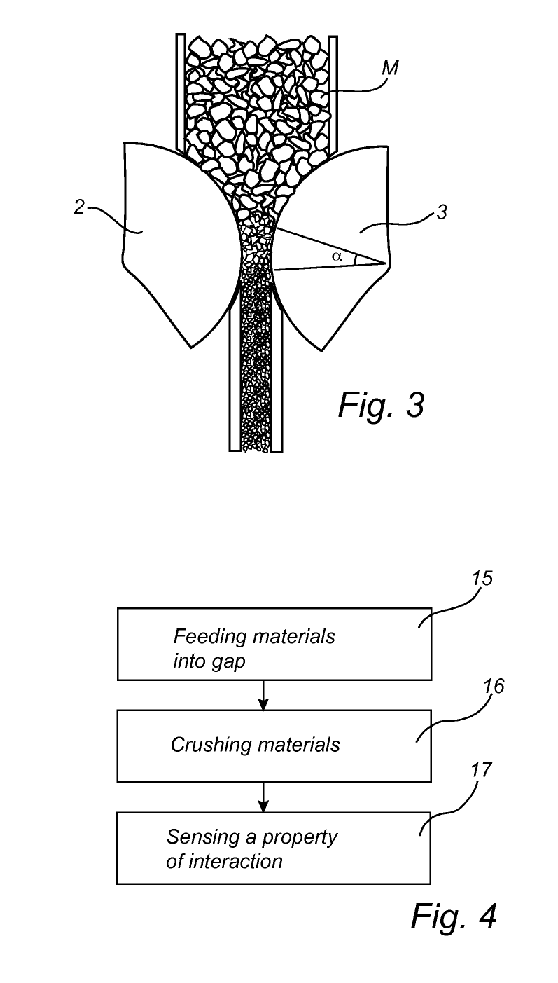

A first opening sensor 11 is connected to the second hydraulic cylinder 8, for measuring the position of the cylinder, which in turn gives the angular position of the second sector shaped roll part 3. In FIG. 3 the nip angle is denoted α and as shown this is the angle, from a horizontal plane, at which the materials M grind against each other to such a degree that interparticle crushing takes place. A similar sensor may be connected to the first hydraulic cylinder and will then perform a corresponding function for the first hydraulic cylinder 7. The measurements of such a sensor may then be combined with the measurements of the first opening sensor 11.

A second opening sensor 12 is connected to the first and the second sector shaped roll parts 2 and 3 and is arranged to measure the distance between the roll parts, which in turn gives the width of the gap 6. The first and the second opening sensors 11 and 12 may be in the form of strain gauges. As an example, the second opening sensor 12 in the form of a strain gauge may be attached to the rotation centers 18 and 19 of the two sector shaped roll parts 2 and 3, and the width of the gap 6 is then easily calculated from the distance measured by the strain gauge between the center points of the roll parts.

The first opening sensor 11, also in the form of a strain gauge, may be attached to the moving part 20 of one of the hydraulic cylinders—in the figures the second cylinder 8—and to the non-moving part 21, thereby measuring the extension of the moving part 20 from the non-moving part 21, which in turn gives the angle of the sector shaped roll parts. The nip angle is defined by the strain gauges measurement, when the crushing starts. The nip angle may then be used to calculate the expected capacity in field use.

A first pressure sensor 13 is connected to the hydraulic unit 9 and is arranged to measure the pressure with which the roll parts are forced or biased against each other, or correspondingly, the pressure which the materials exert on the sector shaped roll parts. By combining this pressure measurement with the pressure measured by a second pressure sensor, described below, the nominal working pressure of the equipment in relation to the application may be defined. This may then be used for optimizing the roller crusher equipment to improve the life time of the machine, reduce the wear and achieve a better performance.

A second pressure sensor 14 is connected to the hydraulic cylinder 7 and 8 and is arranged to measure the force that the hydraulic cylinders use to rotate the two sector shaped roll parts 2 and 3.

As an option, flanges may be mounted on one or both of the sector shaped roll parts 2 and 3 and further sensors may be arranged to measure the effect that the material will have on those flanges as well as the effect that the flanges have on the material being crushed.

In FIG. 4 a method for a test device for a roller crusher is illustrated. In a first step 15 materials M are fed into a gap 6 between the crushing surfaces 4 and 5 of the first and the second sector shaped roll parts 2 and 3. In step 16 the materials, or at least part of the materials, are crushed by interparticle crushing as the two roll parts rotate from the first angular position shown in FIG. 1 to the second position shown in FIG. 2. Finally in step 17 at least one property of the interaction between the materials M and the test device which took place during the crushing, or the rotation of the sector shaped roll parts, is sensed by the sensor arrangement 10. The property sensed could be one of those discussed above, but any property which can be sensed and which will give information on the interaction could be chosen, and the sensing arrangement would then include sensors for that purpose.

1. A test device for a roller crusher of the type which comprises a pair of crushing rolls rotating in opposite directions for crushing or pulverizing materials, comprising
a first sector shaped roll part having a first crushing surface and which is rotatably mounted so that the first crushing surface forms one side of a gap through which materials is fed,
a second sector shaped roll part having a second crushing surface and which is rotatably mounted so that the second crushing surface forms the other side of the gap, and
a sensor arrangement arranged to sense at least one property of the interaction between the materials fed through the gap and the test device.

2. The test device of claim 1, wherein the sensor arrangement comprises an opening sensor arranged to sense the width of the gap.

3. The test device of claim 1 wherein the sensor arrangement comprises a first pressure sensor arranged to sense the pressure exerted on the sector shaped roll parts by the materials fed through the gap.

4. The test device of claim 1, wherein the sensor arrangement comprises a second pressure sensor arranged to sense the force used for rotating the sector shaped roll parts.

5. The test device of claim 1, further comprising a first hydraulic cylinder which is arranged to rotate the first sector shaped roll part, and a second cylinder which is arranged to rotate the second sector shaped roll part.

6. The test device of claim 1, further comprising a hydraulic unit which is arranged to bias the sector shaped roll parts against each other.

7. The test device of claim 1, wherein the sector shaped roll parts are arranged to rotate about 45° from a first angular position to a second angular position during a test session.

8. A method for a test device for a roller crusher of the type which comprises a pair of crushing rolls rotating in opposite directions for crushing or pulverizing material, comprising
feeding materials into a gap, one side of the gap being formed by a first crushing surface of a first rotatably mounted sector shaped roll part and another side of the gap being formed by a second crushing surface of a second rotatably mounted sector shaped roll part,
crushing, by interparticle crushing, at least a portion of the materials, by rotating the first and the second sector shaped roll parts from a first angular position to a second angular position, and
sensing at least one property of the interaction between the materials and the test device.

9. The method of claim 9, further comprising storing the at least one property in a data logging device.

10. The method of claim 9, further comprising calculating the density of the materials based on the at least one property of the interaction.
